(19) United States
(12) Patent Application Publication
(10) Pub. No.: US 2025/0157216 A1
(43) Pub. Date: May 15, 2025

(54) VIDEO MANUAL GENERATION APPARATUS

(71) Applicant: NTT DOCOMO, INC., Tokyo (JP)

(72) Inventors: Nobutaka MATSUSHIMA, Chiyoda-ku (JP); Yuuichi MIZUKOSHI, Chiyoda-ku (JP)

(73) Assignee: NTT DOCOMO, INC., Tokyo (JP)

(21) Appl. No.: 18/854,695

(22) PCT Filed: Mar. 24, 2023
(86) PCT No.: PCT/JP2023/011799

§ 371 Date: Oct. 7, 2024

(30) Foreign Application Priority Data
May 17, 2022 (JP) 2022-080619

(51) Int. Cl. G06V 20/40; G06F 40/20; G06V 10/74; G06V 10/762; G06V 10/774

(52) U.S. Cl. CPC G06V 20/41; G06F 40/20; G06V 10/761; G06V 10/763; G06V 10/774

(57) ABSTRACT

A video manual generation apparatus includes an acquirer configured to acquire: an input-video data set indicative of contents of a task including one or more procedures, and one or more input-procedure-text data sets in one-to-one correspondence with the one or more procedures, an identifier configured to use a task trained model to identify a procedure corresponding to a frame that is any one of a plurality of frames of the input-video data set from among the one or more procedures, the task trained model being trained to learn a relationship between first information and second information, the first information being constituted of a video and one or more texts, the video representing the contents of the task constituted of the one or more procedures, the one or more texts being in one-to-one correspondence with the one or more procedures, the second information indicating a procedure corresponding to a frame that is any one of a plurality of frames of the video among the one or more procedures; and a video manual generator configured to generate video manual data based on the input-video data set and an input-procedure-text data set corresponding to the procedure identified by the identifier from among the one or more input-procedure-text data sets.

### TECHNICAL FIELD

The present invention relates to video manual generation apparatuses for generating video manuals.

### BACKGROUND ART

Patent Document 1 discloses an apparatus for generating video manual data based on a procedure file and a video file. This apparatus recognizes a combination of an object and an action included in the video and recognizes a combination of a noun and a verb included in the procedure file. This apparatus associates, based on the recognition, a scene in the video with a procedure so as to generate video manual data.

### RELATED ART DOCUMENT

### Patent Document

Patent Document 1: Japanese Patent No. 7023427

### SUMMARY OF THE INVENTION

### Problem to be Solved by the Invention

The conventional apparatus needs to recognize a combination of an object and an action; thus, there is a heavy processing load to analyze a video. In addition, when a combination of an object and an action occurs twice during a series of procedures, a disadvantage occurs in that it is impossible to uniquely associate a scene in a video with a procedure.

An object of this disclosure is to provide a video manual generation apparatus for easily generating video manual data.

### Means for Solving Problem

A video manual generation apparatus according to this disclosure includes an acquirer configured to acquire an input-video data set indicative of contents of a task including one or more procedures, and one or more input-procedure-text data sets in one-to-one correspondence with the one or more procedures, an identifier configured to use a task trained model to identify a procedure corresponding to a frame that is any one of a plurality of frames of the input-video data set from among the one or more procedures, the task trained model being trained to learn a relationship between first information and second information, the first information being constituted of a video and one or more texts, the video representing the contents of the task constituted of the one or more procedures, the one or more texts being in one-to-one correspondence with the one or more procedures, the second information indicating a procedure corresponding to a frame that is any one of a plurality of frames of the video among the one or more procedures; and a video manual generator configured to generate video manual data based on the input-video data set and an input-procedure-text data set corresponding to the procedure identified by the identifier from among the one or more input-procedure-text data sets.

### Effect of Invention

According to this disclosure, since a task trained model is used, it is possible to reduce a processing load compared to an apparatus that recognizes a combination of an object and an action. In addition, according to this disclosure, when a combination of an object and an action occurs twice during a series of procedures, it is possible to identify a procedure corresponding to a frame that is any one of a plurality of frames of an input-video data set from among a plurality of procedures.

### BRIEF DESCRIPTION OF THE DRAWINGS

FIG. 1 is a block diagram showing a relationship between input and output of a video manual generation apparatus 1A.

FIG. 2A is an explanatory diagram showing contents of an input-text data set Ti.

FIG. 2B is an explanatory diagram showing a relationship between an input-video data set Vi, the input-text data set Ti, and a video manual data set VM.

FIG. 3A is a block diagram showing an example of a configuration of the video manual generation apparatus 1A.

FIG. 3B is a block diagram showing functions of an identifier 113.

FIG. 4 is an explanatory diagram showing a relationship between video data sets Vy1, Vy2, and Vy3 and procedures 1 to 6.

FIG. 5 is a flowchart showing contents of trained model generation processing.

FIG. 6 is a flowchart showing contents of video manual generation processing.

FIG. 7 is a block diagram showing an example of a configuration of a video manual generation apparatus 1B.

### MODES FOR CARRYING OUT THE INVENTION

### 1: First Embodiment

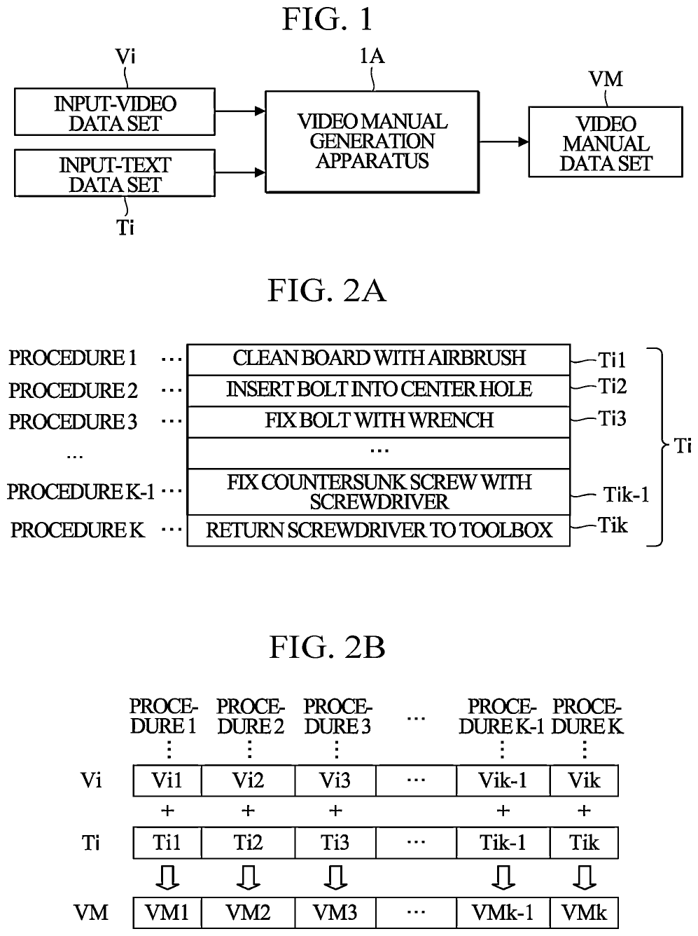

With reference to FIG. 1 to FIG. 6, a video manual generation apparatus 1A for generating a video manual will be described.

### 1. 1: Outline of Embodiment

FIG. 1 is a block diagram showing a relationship between input and output of the video manual generation apparatus 1A. To the video manual generation apparatus 1A, an input-video data set Vi and an input-text data set Ti are input. The input-video data set Vi indicates a video of a task. The task includes k procedures. The k procedures are procedures 1, 2 . . . k. Here, k is an integer greater than or equal to two. The input-text data set Ti indicates a document that describes contents of the k procedures.

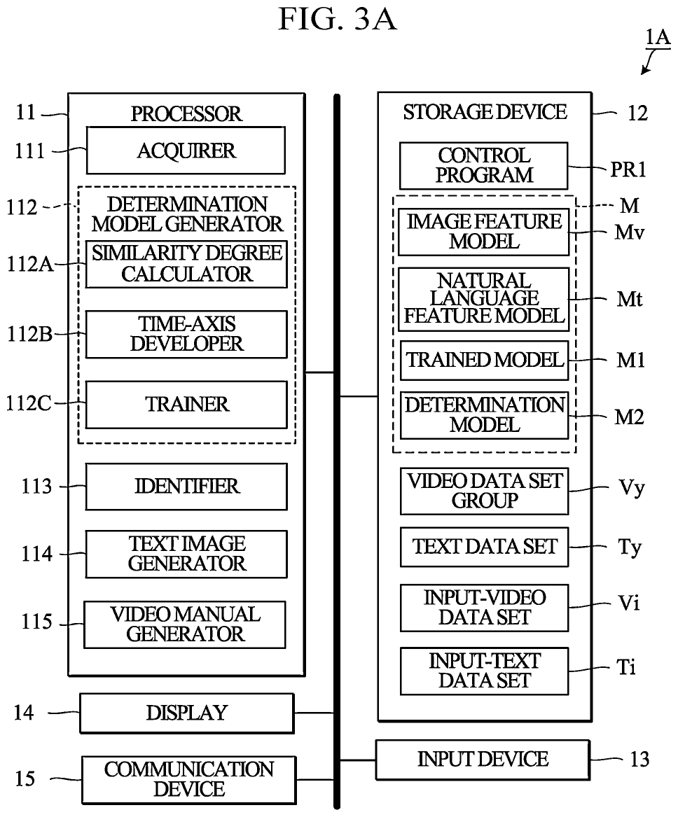

FIG. 2A is an explanatory diagram showing contents of the input-text data set Ti. The input-text data set Ti includes input-procedure-text data sets Ti1, Ti2 . . . . Tik in one-to-one correspondence with the procedures 1, 2 . . . k. For example, the input-procedure-text data set Ti3 corresponds to the procedure 3 and indicates a text such as “FIX BOLT WITH WRENCH.”

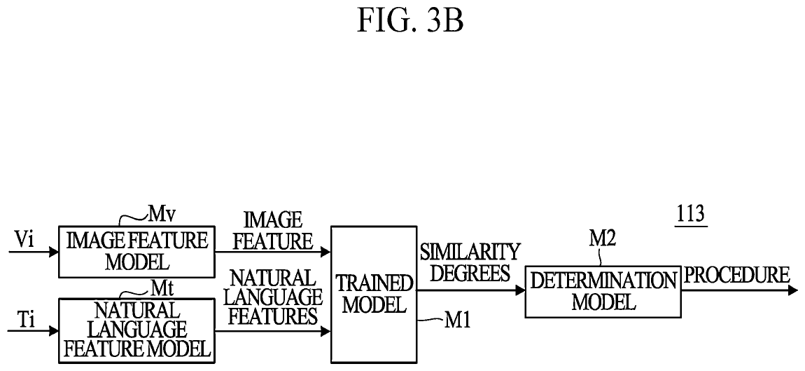

FIG. 2B is an explanatory diagram showing a relationship between the input-video data set Vi, the input-text data set Ti, and a video manual data set VM. The input-video data set Vi includes individual video data sets Vi1, Vi2 . . . . Vik in one-to-one correspondence with the procedures 1, 2 . . . k. A time required for one of the procedures 1, 2 . . . k is different from a time required for another procedure. Thus, a time required to play one of the individual video data sets Vi1, Vi2 . . . . Vik is not necessarily equal to a time required to play another. The input-video data set Vi does not indicate boundaries between the individual video data sets Vi1, Vi2 . . . . Vik. In other words, a relationship between the individual video data sets Vi1, Vi2 . . . . Vik and the procedures 1, 2 . . . k is unknown. In addition, a relationship between the individual video data sets Vi1, Vi2 . . . . Vik and the procedure-text data sets Ti1, Ti2 . . . . Tik is unknown. This relationship is determined by estimation using a determination model M2 shown in FIG. 3.

The video manual data set VM includes individual video data sets VM1, VM2 VMk in one-to-one correspondence with the procedures 1, 2 . . . k. The video manual data set VM is data indicative of a video manual in which the contents of the respective procedures are superimposed on the video of a task. The video manual data set VM is obtained by combining the video indicated by the input-video data set Vi with images of texts indicated by the input-text data set Ti. Specifically, an individual video data set VMj indicates a video obtained by combining an individual video Vij with a text image indicated by a procedure text data set Tij. Here, j is a freely selected integer greater than or equal to one, and less than or equal to k.

### 1. 2: Configuration of Video Manual Generation Apparatus 1A

FIG. 3 is a block diagram showing an example of a configuration of the video manual generation apparatus 1A. The video manual generation apparatus 1A includes a processor 11, a storage device 12, an input device 13, a display 14, and a communication device 15. Each element of the video manual generation apparatus 1A is interconnected by a single bus or by multiple buses for communicating information. The term “apparatus” in this specification may be understood as being equivalent to another term such as circuit, device, unit, etc.

The processor 11 is a processor configured to control the entire video manual generation apparatus 1A. The processor 11 is constituted of a single chip or of multiple chips, for example. The processor 11 is constituted of a central processing unit (CPU) that includes, for example, interfaces for peripheral devices, arithmetic units, registers, etc. One, some, or all of the functions of the processor 11 may be implemented by hardware such as a digital signal processor (DSP), an application specific integrated circuit (ASIC), a programmable logic device (PLD), or a field programmable gate array (FPGA). The processor 11 executes various processing in parallel or sequentially.

The storage device 12 is a recording medium readable and writable by the processor 11. The storage device 12 stores a plurality of programs including a control program PR1 to be executed by the processor 11, an image feature model Mv, a natural language feature model Mt, a trained model M1, a video data set group Vy, a text data set Ty, the determination model M2, the input-video data set Vi, and the input-text data set Ti. The image feature model Mv, the natural language feature model Mt, the trained model M1, and the determination model M2 are each executed by the processor 11. The storage device 12 functions as a work area for the processor 11.

The input device 13 provides an operation signal dependent on an operation by a user. The input device 13 includes a keyboard and a pointing device, for example.

The display 14 is a device for displaying images. The display 14 displays various images under the control of the processor 11. Examples of the display 14 include a liquid crystal display and an organic EL display.

The communication device 15 is hardware that functions as a transmitting and receiving device configured to communicate with other devices. For example, the communication device 15 may be referred to as a network device, a network controller, a network card, a communication module, etc. The communication device 15 may include a connector for wired connection. The communication device 15 may include a wireless communication interface. The connector for wired connection may conform to wired LAN, IEEE1394, or USB. The wireless communication interface may conform to wireless LAN or Bluetooth (registered trademark), etc.

In the above-described configuration, the processor 11 reads the control program PR1 from the storage device 12. The processor 11 executes the read control program PR1 to function as an acquirer 111, a determination model generator 112, an identifier 113, a text image generator 114, and a video manual generator 115.

The acquirer 111 acquires the video data set group Vy, the text data set Ty, the input-video data set Vi, and the input-text data set Ti from an external device via the communication device 15. The acquirer 111 stores the acquired data sets in the storage device 12.

The determination model generator 112 generates the determination model M2 based on the video data set group Vy and the text data set Ty. The determination model generator 112 includes a similarity degree calculator 112A, a time-axis developer 112B, and a trainer 112C.

The video data set group Vy is constituted of h video data sets. The h video data sets are video data sets Vy1, Vy2 . . . . Vyh. Here, h is an integer greater than or equal to 2. The video data sets Vy1, Vy2 . . . . Vyh each indicate a video that represents contents of a first task. The first task is constituted of p procedures. The p procedures are procedures 1, 2 . . . p. Here, p is an integer greater than or equal to 2. It is desirable that p=k be satisfied. The text data set Ty indicates a document that describes contents of the p procedures. The text data set Ty is constituted of procedure text data sets Ty1, Ty2 . . . . Typ in one-to-one correspondence with the procedures 1, 2 . . . p. In other words, machine-learning for the determination model M2 is executed based on the plurality of video data sets indicative of the same task and on the text data sets indicative of texts representing the procedures of the task. To each of the video data sets Vy1, Vy2 . . . . Vyh, information indicative of boundaries between the procedures is not added. Here, h is 50, for example. To facilitate explanation, in the following, a case is assumed in which h is equal to 3, and p is equal to 6.

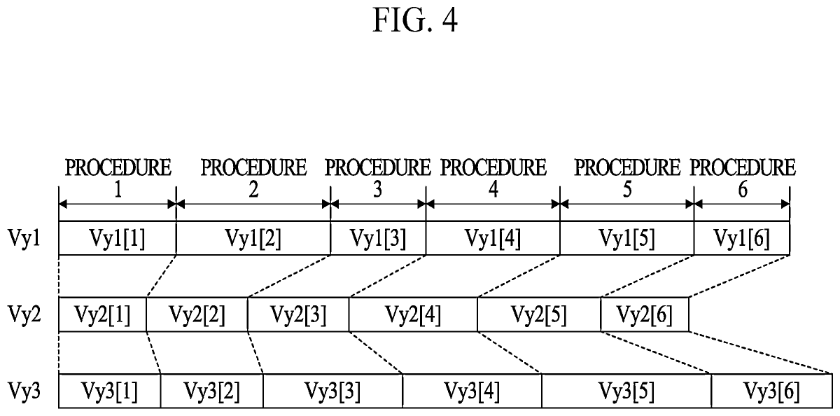

FIG. 4 is an explanatory diagram showing a relationship between the video data sets Vy1, Vy2, and Vy3 and the procedures 1 to 6. As shown in FIG. 4, a time required to play one of the video data sets Vy1, Vy2, and Vy3 is different from a time required to play another. The similarity degree calculator 112A and the time-axis developer 112B associate the video data sets Vy1, Vy2, and Vy3 with the procedures 1 to 6.

The similarity degree calculator 112A calculates similarity degrees indicative of a degree of similarity between a frame image, that is an image of a frame of a video, and natural languages by using the image feature model Mv, the natural language feature model Mt, and the trained model M1. The image feature model Mv is a model trained to learn a relationship between a frame image and an image feature vector. The image feature vector is an example of an image feature. The similarity degree calculator 112A inputs a frame image into the image feature model Mv to acquire an image feature vector corresponding to the input frame image.

The natural language feature model Mt is a model trained to learn a relationship between natural languages and natural language feature vectors. The similarity degree calculator 112A inputs texts into the natural language feature model Mt to acquire natural language feature vectors corresponding to the input texts. The natural language feature vectors are included in examples of natural language features. In this example, the similarity degree calculator 112A acquires six natural language feature vectors in one-to-one correspondence with the procedure text data sets Ty1, Ty2 . . . . Ty6.

The trained model M1 is a model trained to learn a relationship between information, which is constituted of an image feature vector and natural language feature vectors, and similarity degrees described above. The information, which is constituted of the image feature vector and the natural language feature vectors, is an example of third information. The similarity degree calculator 112A inputs an image feature vector and natural language feature vectors into the trained model M1 to acquire similarity degrees.

More specifically, the similarity degree calculator 112A calculates, for each frame of a plurality of frames of the video data set Vy1, a similarity degree S1 between a corresponding frame image and the procedure text data Ty1, a similarity degree S2 between the frame image and the procedure text data Ty2, a similarity degree S3 between the frame image and the procedure text data Ty3, a similarity degree S4 between the frame image and the procedure text data Ty4, a similarity degree S5 between the frame image and the procedure text data Ty5, and a similarity degree S6 between the frame image and the procedure text data Ty6. For example, when the video data set Vy1 indicates a video constituted of 10,000 frames, six similarity degrees are calculated for each of the frames. The six similarity degrees are the similarity degrees S1 to S6. Thus, 60,000 similarity degrees are calculated for the entire video data set Vy1. The similarity degree calculator 112A calculates similarity degrees S1 to S6 for each frame of a plurality of frames of the video data set Vy2 and calculates similarity degrees S1 to S6 for each frame of a plurality of frames of the video data set Vy3, as in the video data set Vy1. As described above, similarity degrees S1 to S6 are obtained for each frame of a plurality of frames of the video data sets Vy1, Vy2, and Vy3.

The similarity degree calculator 112A further calculates similarity degrees by executing a simple average of, or a weighted average of, similarity degrees obtained for a current frame and similarity degrees obtained for at least one frame previous to the current frame. Similarity degrees for an Nth frame are referred to as S1[N], S2[N], S3[N], S4[N], S5[N], and S6[N]. S1[N], S2[N], S3[N], S4[N], S5[N], and S6[N] are obtained based on the following equations:

$$\begin{matrix}S 1 [ N ] = α1 \times S 1 [ N ] + α 2 \times S 1 [ N - 1 ] + α3 \times S 1 [ N - 2 ] + … + α r \times S 1 [ N - ( r - 1 ) ] , \\ S 2 [ N ] = α 1 \times S 2 [ N ] + α 2 \times S 2 [ N - 1 ] + α 3 \times S 2 [ N - 2 ] + … + α r \times S 2 [ N - ( r - 1 ) ] , \\ S 3 [ N ] = α 1 \times S 3 [ N ] + α 2 \times S 3 [ N - 1 ] + α 3 \times S 3 [ N - 2 ] + … + α r \times S 3 [ N - ( r - 1 ) ] , \\ S 4 [ N ] = α 1 \times S 4 [ N ] + α 2 \times S 4 [ N - 1 ] + α 3 \times S 4 [ N - 2 ] + … + α r \times S 4 [ N - ( r - 1 ) ] , \\ S 5 [ N ] = α 1 \times S 5 [ N ] + α 2 \times S 5 [ N - 1 ] + α 3 \times S 5 [ N - 2 ] + … + α r \times S 5 [ N - ( r - 1 ) ] , and \\ S 6 [ N ] = α 1 \times S 6 [ N ] + α 2 \times S 6 [ N - 1 ] + α 3 \times S 6 [ N - 2 ] + … + α r \times S 6 [ N - ( r - 1 ) ] .\end{matrix}$$

Here, α1+α2+α3+ . . . +αr=1, and α1≥α2≥α3≥ . . . ≥αr are satisfied. When α1=α2=α3= . . . =αr is satisfied, calculated similarity degrees are each a simple average; however, when α1>α2>α3> . . . >αr is satisfied, calculated similarity degrees are each a weighted average.

The time-axis developer 112B applies self-supervised learning (Temporal Cycle-Consistent Learning) to the video data sets Vy1, Vy2, and Vy3 to align actions indicated by the video data set Vy1 and actions indicated by each of the video data sets Vy2 and Vy3 with each other on a time-axis, the actions indicated by each of the video data sets Vy2 and Vy3 being the same as the actions indicated by the video data set Vy1. This processing causes the plurality of frames that constitute the video data set Vy1, the plurality of frames that constitute the video data set Vy2, and the plurality of frames that constitute the video data set Vy3 to be in association with one another. The time-axis developer 112B plots the similarity degrees S1 to S6, which has been calculated by the similarity degree calculator 112A, in the frames of the video data sets Vy1, Vy2, and Vy3 that are in association with one another.

The trainer 112C executes non-hierarchical clustering based on a similarity degree plot obtained by the time-axis developer 112B. In this embodiment, k-means clustering is used which is an example of non-hierarchical clustering.

The trainer 112C sets a total number of procedures as the number of clusters. In this embodiment, the total number of procedures is six; thus, the number of clusters is set to six. Data sets for training are sets of similarity degrees S1[N], S2[N], S3[N], S4[N], S5[N], and S6[N] for the frames of the video data sets Vy1, Vy2, and Vy3.

The trainer 112C executes first processing to fourth processing. In the first processing, the trainer 112C sets centroids of the clusters at random locations, the number of centroids being equal to the number of clusters determined in advance (six in this example). In the second processing, the trainer 112C calculates a distance between each of the centroids of the clusters and a data set that is any one of the data sets for training. In the third processing, the trainer 112C classifies, based on the calculated distance, the data set that is any one of the data sets into a cluster having a centroid closest to the data set. In the fourth processing, the trainer 112C repeats the first processing to the third processing until the classification of the data set is not changed. The trainer 112C executes the first processing to the fourth processing to cause the determination model M2 to be trained to learn a relationship between similarity degrees and a procedure number. The procedure number is a number indicative of a procedure represented by a corresponding frame. In other words, the procedure number indicates a procedure corresponding to the frame among the plurality of procedures.

The determination model M2 is constituted of a deep neural network, for example. For example, a freely selected type of deep neural network such as a recurrent neural network (RNN) or a convolutional neural network (CNN) is used as the determination model M2. The determination model M2 may be constituted of a combination of various types of deep neural networks. The determination model M2 may include additional elements, such as Long Short-Term Memory (LSTM) or Attention.

The identifier 113 uses the image feature model Mv, the natural language feature model Mt, the trained model M1, and the determination model M2 to identify a procedure corresponding to a frame that is any one of a plurality of frames of the input-video data set Vi from among the procedures 1 to 6. The image feature model Mv, the natural language feature model Mt, the trained model M1, and the determination model M2 are included in a task trained model M. The task trained model M is a model trained to learn a relationship between first information and second information. The first information is constituted of the video data sets Vy1 to Vyh each indicative of the contents of the task constituted of the p procedures, and of the procedure text data sets Ty1 to Typ in one-to-one correspondence with the p procedures. The second data indicates a procedure corresponding to a frame that is any one of a plurality of frames of the video data sets Vy1 to Vyh among the p procedures.

FIG. 3B is a block diagram showing the functions of the identifier 113. The identifier 113 uses the image feature model Mv to acquire an image feature vector for the frame that is any one of the plurality of frames of the input-video data set Vi. The identifier 113 uses the natural language feature model Mt to acquire natural language feature vectors for the input-procedure-text data sets Ti1 to Tik. The identifier 113 uses the trained model M1 to acquire, for the frame that is any one of the plurality of frames of the input-video data set Vi, similarity degrees corresponding to the acquired image feature vector and corresponding to the acquired natural language feature vectors. The identifier 113 uses the determination model M2 to identify, based on the acquired similarity degrees, the procedure corresponding to the frame that is any one of the plurality of frames of the input-video data set Vi from among the k procedures.

The identifier 113 may calculate similarity degrees by executing a simple average of, or a weighted average of, similarity degrees obtained by using a current frame of the input-video data set Vi and similarity degrees obtained by using at least one frame previous to the current frame. In this case, the identifier 113 uses the determination model M2 to acquire, for the current frame that is any one of the plurality of frames of the input-video data set Vi, a procedure corresponding to the calculated similarity degrees.

The text image generator 114 generates, based on the input-procedure-text data sets Ti1 to Tik that constitute the input-text data set Ti, a text image representing a procedure that is any one of the k procedures.

The video manual generator 115 generates the video manual data set VM based on a procedure text data set corresponding to the procedure identified by the identifier 113 and on the input-video data set Vi. Specifically, the video manual generator 115 generates the video manual data MV by combining a text image corresponding to the procedure identified by the identifier 113 with a frame image corresponding to the procedure identified by the identifier 113, the frame image being of the input-video data set Vi.

### 1. 3: Operations of Video Manual Generation Apparatus 1A

Operations of the video manual generation apparatus 1A are divided into trained model generation processing and video manual generation processing, which will be described.

### 1. 3. 1: Trained Model Generation Processing

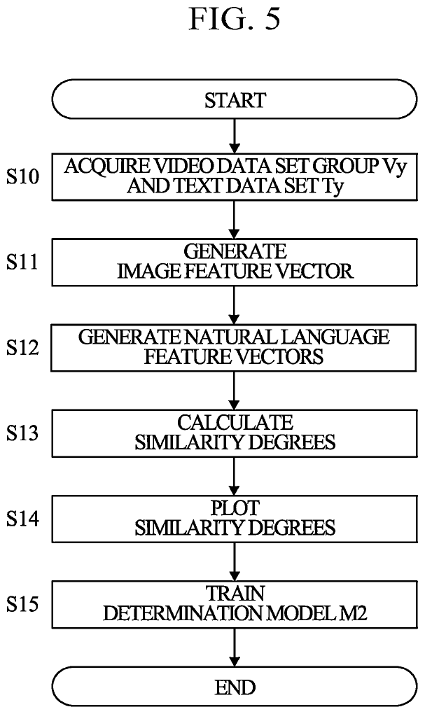

FIG. 5 is a flowchart showing contents of the trained model generation processing. At step S10, the processor 11 acquires the video data set group Vy and the text data set Ty via the communication device 15. In this embodiment, the video data set group Vy includes the video data sets Vy1, Vy2, and Vy3 related to the first task. The text data set Ty includes the procedure text data sets Ty1 to Ty6 that are in one-to-one correspondence with the procedures 1 to 6 of the first task.

At step S11, the processor 11 inputs a frame image of a frame that is any one of the frames of the video data sets Vy1, Vy2, and Vy3 into the image feature model Mv to acquire an image feature vector corresponding to the input frame image.

At step S12, the processor 11 inputs the procedure text data sets Ty1 to Ty6 into the natural language feature model Mt to acquire natural language feature vectors corresponding to the input procedure text data sets Ty1 to Ty6.

At step S13, the processor 11 uses the trained model M1 to calculate, for the frame that is any one of the frames of the video data sets Vy1, Vy2, and Vy3, a similarity degree S1 between the frame image and the procedure text data Ty1, a similarity degree S2 between the frame image and the procedure text data Ty2, a similarity degree S3 between the frame image and the procedure text data Ty3, a similarity degree S4 between the frame image and the procedure text data Ty4, a similarity degree S5 between the frame image and the procedure text data Ty5, and a similarity degree S6 between the frame image and the procedure text data Ty6.

At step S14, the processor 11 applies self-supervised learning (Temporal Cycle-Consistent Learning) to the video data sets Vy1, Vy2 and Vy3 to associate the plurality of frames that constitute the video data set Vy1, the plurality of frames that constitutes the video data set Vy2, and the plurality of frames that constitute the video data set Vy3 with one another. In addition, the processor 11 plots the similarity degrees S1 to S6, which are calculated at step S13, in the frames of the video data sets Vy1, Vy2, and Vy3 that are in association with one another.

At step S15, the processor 11 trains, based on a similarity degree plot obtained at step S14, the determination model M2 through k-means clustering that is an example of non-hierarchical clustering.

In the above-described processing, at step S10, the processor 11 functions as the acquirer 111. At steps S11, S12, and S13, the processor 11 functions as the similarity degree calculator 112A. At step S14, the processor 11 functions as the time-axis developer 112B. At step S15, the processor 11 functions as the trainer 112C.

### 1. 3. 2: Video Manual Generation Processing

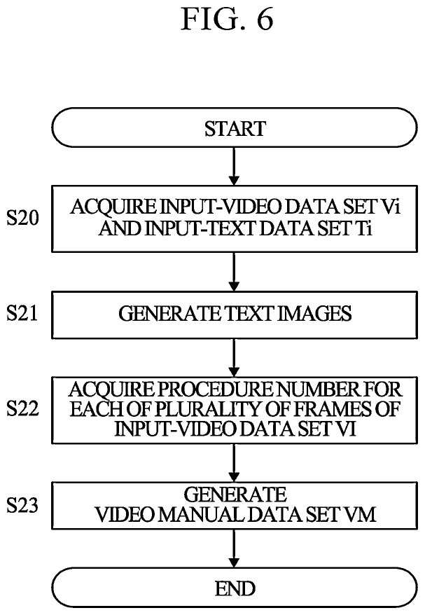

FIG. 6 is a flowchart showing contents of the video manual generation processing. At step S20, the processor 11 acquires the input-video data set Vi and the input-text data set Ti via the communication device 15.

At step S21, the processor 11 generates, based on the input-procedure-text data sets Ti1 to Tik that constitute the input-text data set Ti, a text image representing a procedure that is any one of the k procedures.

At step S22, the processor 11 inputs the image data set of the frame that is any one of the plurality of frames of the input-video data set Vi and the input-text data set Ti into the task trained model M to acquire a procedure number for the frame that is any one of the plurality of frames of the input-video data set Vi. In particular, the processor 11 uses the image feature model Mv to acquire an image feature vector for the frame that is any one of the plurality of frames of the input-video data set Vi. The processor 11 uses the natural language feature model Mt to acquire natural language feature vectors for the input-procedure-text data sets Ti1 to Tik. The processor 11 uses the trained model M1 to acquire, for the frame that is any one of the plurality of frames of the input-video data set Vi, similarity degrees corresponding to the acquired image feature vector and corresponding to the acquired natural language feature vectors. The processor 11 uses the determination model M2 to identify, based on the acquired similarity degrees, a procedure number indicative of a procedure corresponding to the frame that is any one of the plurality of frames of the input-video data set Vi, the procedure being among the k procedures.

At step S23, the processor 11 generates the video manual data set VM by combining, per each frame of the plurality of frames of the input-video data set Vi, the input-video data set Vi with a text image for a corresponding procedure number. In the above-described processing, at step S20, the processor 11 functions as the acquirer 111. At step S21, the processor 11 functions as the text image generator 113. At step S22, the processor 11 functions as the identifier 113. At step S23, the processor 11 functions as the video manual generator 114.

### 1. 4.: Effect of First Embodiment

As described above, the video manual generation apparatus 1A includes the acquirer 111, the identifier 113, and the video manual generator 114. The acquirer 111 acquires the input-video data set Vi indicative of the contents of the task including the plurality of procedures, and the plurality of input-procedure-text data sets Ti1 to Tik in one-to-one correspondence with the plurality of procedures. The identifier 113 uses the task trained model M to identify a procedure corresponding to a frame that is any one of the plurality of frames of the input-video data set Vi from among the plurality of procedures. The task trained model M is a model trained to learn the relationship between the first information and the second information. The first information is constituted of the video and the plurality of texts, the video representing the contents of the task constituted of the plurality of procedures, the plurality of texts being in one-to-one correspondence with the plurality of procedures. The second information indicates a procedure corresponding to a frame that is any one of a plurality of frames of the video among the plurality of procedures. The video manual generator 114 generates the video manual data set VM based on the input-video data set Vi and an input-procedure-text data set corresponding to the procedure identified by the identifier 113 from among the plurality of input-procedure-text data sets Ti1 to Tik.

Since the video manual generation apparatus 1A includes the above-described configuration, it is possible to reduce a processing load compared to an apparatus that recognizes a combination of an object and an action. In addition, the video manual generation apparatus 1A can identify a procedure corresponding to a frame that is any one of the plurality of frames of the input-video data set Vi from among the plurality of procedures when a combination of an object and an action occurs twice during a series of procedures.

The task trained model M includes the image feature model Mv, the natural language feature model Mt, the trained model M1, and the determination model M2. The image feature model Mv is a model trained to learn the relationship between a frame image of the video and an image feature. The natural language feature model Mt is a model trained to learn the relationship between natural languages and natural language features. The trained model M1 is a model trained to learn the relationship between the third information, which is constituted of an image feature and natural language features, and similarity degrees indicative of a degree of similarity between a frame image and natural languages. The determination model M2 is a model trained to learn a relationship between fourth information and fifth information, the fourth information being constituted of similarity degrees and a frame, the fifth information being indicative of a procedure corresponding to the similarity degrees and corresponding to the frame, the procedure being among the plurality of procedures. The identifier 113 uses the image feature model Mv to acquire an image feature for the frame that is any one of the plurality of frames of the input-video data set Vi. The identifier 113 uses the natural language feature model Mt to acquire natural language features for the plurality of input-procedure-text data sets Ti1 to Tik. The identifier 113 uses the trained model M1 to acquire, for the frame that is any one of the plurality of frames of the input-video data set Vi, similarity degrees corresponding to the acquired image feature and corresponding to the acquired natural language features. The identifier 113 uses the determination model M2 to identify, based on the acquired similarity degrees, the procedure corresponding to the frame that is any one of the plurality of frames of the input-video data set Vi from among the plurality of procedures.

The identifier 113 can identify, based on similarity degrees between an image and text, a procedure corresponding to a frame that is any one of the plurality of frames of the input-video data set Vi from among a plurality of procedures.

The identifier 113 may calculate similarity degrees by executing a simple average of, or a weighted average of, similarity degrees obtained by using a current frame of the input-video data set Vi and similarity degrees obtained by using a frame previous to the current frame. In a configuration in which similarity degrees are calculated by executing a simple average or a weighted average, the identifier 113 uses the determination model M2 to acquire, for the frame that is any one of the plurality of frames of the input-video data set Vi, a procedure corresponding to the calculated similarity degrees. The identifier 113 calculates similarity degrees not only in view of a current frame, but also in view of a previous frame; thus, it is possible to appropriately identify a procedure corresponding to a current frame compared to a configuration in which a previous frame is not viewed.

The determination model M2 is trained to learn, through non-hierarchical clustering, a relationship between similarity degrees and a procedure represented by a frame among the plurality of procedures. Since the determination model M2 is generated through non-hierarchical clustering, the determination model M2 can be generated without training data sets. Thus, to train the determination model M2, annotations are not required; as a result, it is possible to reduce a processing load for training the determination model M2.

The video manual generation apparatus 1A includes the text image generator 114 configured to generate the plurality of text images in one-to-one correspondence with the plurality of procedures based on the plurality of input-procedure-text data sets Ti1 to Tik. Each of the plurality of text images represents a corresponding procedure. The video manual generator 114 generates the video manual data Mv by combining a text image corresponding to the procedure identified by the identifier 113 with a corresponding frame image of the input-video data set Vi. Thus, the video manual generation apparatus 1A can add a text image representing a procedure to the input-video data set Vi.

### 2: Second Embodiment

In the First Embodiment, the video data set group Vy is constituted of h video data sets. The h video data sets are the video data sets Vy1, Vy2, Vy3 . . . . Vyh. To each of the video data sets Vy1, Vy2, Vy3 . . . . Vyh, the information indicative of the boundaries between the procedures is not added. In contrast, in a Second Embodiment, a configuration is assumed in which the information indicative of the boundaries between the procedures is added to the video data set Vy1, whereas the information indicative of the boundaries between the procedures is not added to the video data sets Vy2, Vy3 . . . . Vyh. The information indicative of the boundaries between the procedures is frame information indicative of a frame number of the end frame in each of the procedures. For example, when there are k procedures, the frame information indicates k frame numbers.

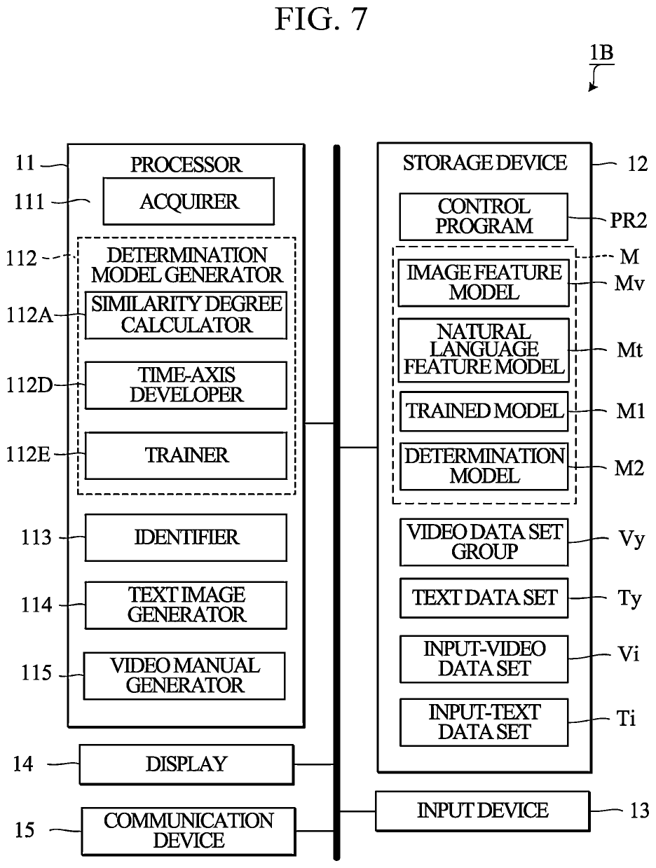

FIG. 7 is a block diagram showing an example of a configuration of a video manual generation apparatus 1B according to the Second Embodiment. The video manual generation apparatus 1B has the same configuration as the video manual generation apparatus 1A according to the First Embodiment shown in FIG. 3 except for the following points. The video manual generation apparatus 1B differs from the video manual generation apparatus 1A in that a control program PR2 is included in place of the control program PR1, a time-axis developer 112D is included in place of the time-axis developer 112B, and a trainer 112E is included in place of the trainer 112C.

The time-axis developer 112D applies self-supervised learning (Temporal Cycle-Consistent Learning) to the video data sets Vy1, Vy2, Vy3 . . . . Vyh to align, based on the video data set Vy1, actions indicated by the video data set Vy1 and actions indicated by each of the video data sets Vy2, Vy3 . . . . Vyh with each other on the time-axis, the actions indicated by each of the video data sets Vy2, Vy3 . . . . Vyh being the same as the actions indicated by the video data set Vy1. This processing causes the plurality of frames included in the video data set Vy1 and a plurality of frames included in the video data sets Vy2, Vy3 . . . . Vyh to be in association with each other. As a result, a frame number of the end frame in each of the plurality of procedures in the video data set Vy1 is in association with frame numbers of corresponding frames of the video data sets Vy2, Vy3 . . . Vyh. In other words, the time-axis developer 112D can reflect the information indicative of the boundaries between the procedures, which is added to the video data set Vy1, on the other video data sets Vy2, Vy3 . . . . Vyh.

The trainer 112E determines a procedure number for each frame of frames of the video data sets Vy1, Vy2, Vy3 . . . . Vyh based on frame numbers indicative of the boundaries between the procedures. The trainer 112E generates a plurality of training data sets based on a set of similarity degrees S1[N], S2[N], S3[N], S4[N], S5[N], and S6[N] for each frame of the frames and on the procedure number for each frame of the frames. A training data set is constituted of a set of input data and label data. The input data indicates similarity degrees. The label data indicates a procedure number.

The trainer 112E trains a determination model M2 with the plurality of training data sets to generate the determination model M2 that is trained. The determination model M2 is constituted of a deep neural network, for example. For example, a freely selected type of deep neural network such as a recurrent neural network (RNN) or a convolutional neural network (CNN) is used as the determination model M2. The determination model M2 may be constituted of a combination of various types of deep neural networks. The determination model M2 may include additional elements, such as Long Short-Term Memory (LSTM) or Attention.

The trainer 112E differs from the trainer 112C in that: the trainer 112E does not execute non-hierarchical clustering, the trainer 112E generates the plurality of training data sets using the frames of the video data sets Vy1, Vy2, Vy3 . . . . Vyh and the procedure numbers, which are in association with each other, and the trainer 112E trains the determination model M2 with the plurality of training data sets.

The determination model M2 is trained on the plurality of training data sets. Each of the plurality of training data sets is a set of input data and label data, the input data indicating similarity degrees for a frame that is any one of a plurality of frames of the plurality of video data sets Vy1 to Vyh, the label data indicating a procedure represented by the frame that is any one of the plurality of frames of the plurality of video data sets Vy1 to Vyh. The plurality of video data sets Vy1 to Vyh includes the first video data set Vy1 to which the information indicative of the boundaries between the plurality of procedures is added. Applying self-supervised learning to the plurality of video data sets Vy1 to Vyh causes the information indicative of the boundaries between the plurality of procedures to be added to the video data sets Vy2 to Vyh other than the first video data set Vy1 among the plurality of video data sets. The label data is generated based on the information indicative of the boundaries between the plurality of procedures added to the plurality of video data sets Vy1 to Vyh. Thus, according to the video manual generation apparatus 1B, the information indicative of the boundaries between the plurality of procedures added to the video data set Vy1 is reflected in the video data sets Vy2, Vy3 . . . . Vyh; as a result, it is possible to reduce annotations related on the boundaries between the plurality of procedures to 1/h.

### 3: Modifications

This disclosure is not limited to the Embodiments described above. Specific modifications will be explained below. Two or more modifications freely selected from the following modifications may be combined.

### 3. 1: First Modification

In the First Embodiment and the Second Embodiment described above, the trained model M1 is trained to learn the relationship between the third information (an image feature of a frame image of a video data set and natural language features of procedure text data sets) and similarity degrees. In a First Modification, a trained model M3 is included in place of the trained model M1. The trained model M3 is trained to learn a relationship between sixth information and similarity degrees. The sixth information is constituted of an image feature of a video constituted of a series of multiple frames and natural language features of procedure text data sets. For example, the trained model M3 may be trained by a video with a subtitle. The image feature of the video constituted of the series of multiple frames may be acquired through processing by which the image feature model Mv is used to calculate image features of the multiple frames, and the calculated image features are combined. Alternatively, in place of the image feature model Mv, a video feature model may be included that is trained to learn a relationship between a video constituted of a series of multiple frames and an image feature. The video feature model may be constituted of a neural network that three-dimensionally convolves an image of each of the multiple frames.

### 3. 2: Second Modification

In the First Embodiment, the Second Embodiment, and the First Modification described above, the input-video data set Vi indicates the contents of the task including the plurality of procedures, and the input-text data set Ti is constituted of the plurality of input-procedure-text data sets Ti1 to Tik in one-to-one correspondence with the plurality of procedures. However, this disclosure is not limited to the plurality of procedures, and a single procedure may be used. In other words, the task may be constituted of one or more procedures. When the task is constituted of one or more procedures, the video manual generation apparatus may have the following configuration. The video manual apparatus includes an acquirer, an identifier, a video manual generator, and a text image generator. The acquirer acquires an input-video data set indicative of contents of a task including one or more procedures, and one or more input-procedure-text data sets in one-to-one correspondence with the one or more procedures. The identifier uses a task trained model to identify a procedure corresponding to a frame that is any one of a plurality of frames of the input-video data set from among the one or more procedures. The task trained model is a model trained to learn a relationship between first information and second information. The first information is constituted of a video and one or more texts, the video representing the contents of the task constituted of the one or more procedures, the one or more texts being in one-to-one correspondence with the one or more procedures. The second information indicates a procedure corresponding to a frame that is any one of a plurality of frames of the video among the one or more procedures. The video manual generator generates video manual data based on the input-video data set and an input-procedure-text data set corresponding to the procedure identified by the identifier from among the one or more input-procedure-text data sets. The text image generator generates one or more text images in one-to-one correspondence with the one or more procedures based on the one or more input-procedure-text data sets. Each of the one or more text images represents a corresponding procedure. The video manual generator generates the video manual data by combining a text image corresponding to the procedure identified by the identifier with the frame image of the input-video data set.

### 3. 3: Third Modification

In the First Embodiment, the Second Embodiment, the First Modification, and the Second Modification described above, the video manual data set VM is a video data set in which the text images are combined with the input-image data set Vi. However, this disclosure is not limited thereto. The video manual data set VM may be constituted of the input-image data set Vi, the one or more input-procedure-text data sets Ti1 to Tik, and association data set. The association data set indicates an input-procedure-text data set corresponding to a frame that is any one of the plurality of frames of the input-image data set Vi among the one or more input-procedure-text data sets Ti1 to Tik. The video manual generation apparatus may receive the input-image data set Vi and the input-text data set Ti from an information processing apparatus via a communication network. The video manual generation apparatus may generate the video manual data set VM based on the received input-image data set Vi and the received input-text data set Ti. The video manual generation apparatus may transmit the generated video manual data set VM to the information processing apparatus.

### 4: Other Matters

(1) In the foregoing embodiments and the modifications, the storage device 12 may include a ROM, a RAM, etc. The storage device 12 include flexible disks, magneto-optical disks (e.g., compact disks, digital multi-purpose disks, Blu-ray (registered trademark) discs, smart-cards, flash memory devices (e.g., cards, sticks, key drives), Compact Disc-ROMs (CD-ROMs), registers, removable discs, hard disks, floppy (registered trademark) disks, magnetic strips, databases, servers, or other suitable storage mediums. The program may be transmitted by a network via telecommunication lines. Alternatively, the program may be transmitted by a communication network NET via telecommunication lines.
(2) In the foregoing embodiments and the modifications, information, signals, etc., may be presented by use of various techniques. For example, data, instructions, commands, information, signals, bits, symbols, chips, etc., may be presented by freely selected combinations of voltages, currents, electromagnetic waves, magnetic fields or magnetic particles, light fields or photons.
(3) In the foregoing embodiments and the modifications, the input and output of information, or the input or the output of information, etc., may be stored in a specific location (e.g., in a memory) or may be managed by use of a management table. The information, etc., that is, the input and output, or the input or the output, may be overwritten, updated, or appended. The information, etc., that is output may be deleted. The information, etc., that is input may be transmitted to other devices.
(4) In the foregoing embodiments and the modifications, determination may be made based on values that can be represented by one bit (0 or 1), may be made based on Boolean values (true or false), or may be made based on comparing numerical values (for example, comparison with a predetermined value).
(5) The order of processes, sequences, flowcharts, etc., that have been used to describe the foregoing embodiments and the modifications may be changed as long as they do not conflict. For example, although a variety of methods has been illustrated in this disclosure with a variety of elements of steps in exemplary orders, the specific orders presented herein are by no means limiting.
(6) Each function shown in FIG. 1 to FIG. 7 may be implemented by any combination of hardware and software. The method for realizing each functional block is not limited thereto. That is, each functional block may be implemented by one device that is physically or logically aggregated. Alternatively, each functional block may be realized by directly or indirectly connecting two or more physically and logically separate, or physically or logically separate, devices (by using cables and radio, or cables, or radio, for example), and using these devices. The functional block may be realized by combining the software with one device described above or with two or more of these devices.
(7) The programs shown in the foregoing embodiments and the modifications should be widely interpreted as an instruction, an instruction set, a code, a code segment, a program code, a subprogram, a software module, an application, a software application, a software package, a routine, a subroutine, an object, an executable file, an execution thread, a procedure, a function, or the like, regardless of whether it is called software, firmware, middleware, microcode, hardware description language, or by other names.

Software, instructions, etc., may be transmitted and received via communication media. For example, when software is transmitted by a website, a server, or other remote sources, by using wired technologies such as coaxial cables, optical fiber cables, twisted-pair cables, and digital subscriber lines (DSL), and wireless technologies such as infrared radiation and radio and microwaves by using wired technologies, or by wireless technologies, these wired technologies and wireless technologies, wired technologies, or wireless technologies, are also included in the definition of communication media.
(8) The information and parameters described in this disclosure may be represented by absolute values, may be represented by relative values with respect to predetermined values, or may be represented by using other pieces of applicable information.
(9) In the foregoing embodiments and the modifications, the terms “connected” and “coupled”, or any modification of these terms, may mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be replaced with “access.” As used in this specification, two elements may be considered “connected” or “coupled” to each other by using one or more electrical wires, cables, and printed electrical connections, or by using one or more electrical wires, cables, or printed electrical connections. In addition, two elements may be considered “connected” or “coupled” to each other by using electromagnetic energy, etc., which is a non-limiting and non-inclusive example, having wavelengths in radio frequency regions, microwave regions, and optical (both visible and invisible) regions.
(10) In the foregoing embodiments and the modifications, the phrase “based on” as used in this specification does not mean “based only on”, unless specified otherwise. In other words, the phrase “based on” means both “based only on” and “based at least on.”
(11) The term “determining” as used in this specification may encompass a wide variety of actions. For example, the term “determining” may be used when practically “determining” that some act of calculating, computing, processing, deriving, investigating, looking up (for example, looking up a table, a database, or some other data structure), ascertaining, etc., has taken place. Furthermore, “determining” may be used when practically “determining” that some act of receiving (for example, receiving information), transmitting (for example, transmitting information), inputting, outputting, accessing (for example, accessing data in a memory) etc., has taken place. Furthermore, “determining” may be used when practically “determining” that some act of resolving, selecting, choosing, establishing, comparing, etc., has taken place. That is, “determining” may be used when practically determining to take some action. The term “determining” may be replaced with “assuming”, “expecting”, “considering”, etc.
(12) As long as terms such as “include”, “including” and modifications thereof are used in the foregoing embodiments and the modifications, these terms are intended to be inclusive, in a manner similar to the way the term “comprising” is used. In addition, the term “or” used in the specification or in claims is not intended to be the exclusive OR.
(13) In the present disclosure, for example, when articles such as “a”, “an”, and “the” in English are added in translation, these articles include plurals unless otherwise clearly indicated by the context.
(14) In this disclosure, the phrase “A and B are different” may mean “A and B are different from each other.” Alternatively, the phrase “A and B are different” may mean that “each of A and B is different from C.” Terms such as “separated” and “combined” may be interpreted in the same way as “different.”
(15) The embodiment and the modifications illustrated in this specification may be used individually or in combination, which may be altered depending on the mode of implementation. A predetermined piece of information (for example, a report to the effect that something is “X”) does not necessarily have to be indicated explicitly, and it may be indicated in an implicit way (for example, by not reporting this predetermined piece of information, by reporting another piece of information, etc.).

Although this disclosure is described in detail, it is obvious to those skilled in the art that the present invention is not limited to the embodiment described in the specification. This disclosure can be implemented with a variety of changes and in a variety of modifications, without departing from the spirit and scope of the present invention as defined in the recitations of the claims. Consequently, the description in this specification is provided only for the purpose of explaining examples and should by no means be construed to limit the present invention in any way.

### DESCRIPTION OF REFERENCE SIGNS

1A, 1B . . . video manual generation apparatus, 11 . . . processor, 111 . . . acquirer, 113 . . . identifier, 114 . . . text image generator, 115 . . . video manual generator, M . . . task trained model, M1 . . . trained model, M2 . . . determination model, M3 . . . trained model, MV . . . video manual data set, Mt . . . natural language feature model, Mv . . . image feature model, My . . . natural language feature model.

1. A video manual generation apparatus comprising:
an acquirer configured to acquire:
an input-video data set indicative of contents of a task including one or more procedures, and
one or more input-procedure-text data sets in one-to-one correspondence with the one or more procedures;
an identifier configured to use a task trained model to identify a procedure corresponding to a frame that is any one of a plurality of frames of the input-video data set from among the one or more procedures, the task trained model being trained to learn a relationship between first information and second information, the first information being constituted of a video and one or more texts, the video representing the contents of the task constituted of the one or more procedures, the one or more texts being in one-to-one correspondence with the one or more procedures, the second information indicating a procedure corresponding to a frame that is any one of a plurality of frames of the video among the one or more procedures; and
a video manual generator configured to generate video manual data based on the input-video data set and an input-procedure-text data set corresponding to the procedure identified by the identifier from among the one or more input-procedure-text data sets.

2. The video manual generation apparatus according to claim 1,
wherein the task includes a plurality of procedures,
wherein the task trained model includes:
an image feature model trained to learn a relationship between a frame image and an image feature, the frame image being an image of the frame of the video;
a natural language feature model trained to learn a relationship between natural languages and natural language features;
a trained model trained to learn a relationship between third information and similarity degrees indicative of a degree of similarity between the frame image and natural languages, the third information being constituted of the image feature and natural language features; and
a determination model trained to learn a relationship between fourth information and fifth information, the fourth information being constituted of the similarity degrees and the frame corresponding to the frame image, the fifth information being indicative of a procedure corresponding to the similarity degrees and corresponding to the frame corresponding to the frame image among the plurality of procedures, wherein the identifier is configured to:
use the image feature model to acquire an image feature for the frame that is any one of the plurality of frames of the input-video data set,
use the natural language feature model to acquire natural language features for the input-procedure-text data sets,
use the trained model to acquire, for the frame that is any one of the plurality of frames of the input-video data set, similarity degrees corresponding to the acquired image feature and corresponding to the acquired natural language features, and
use the determination model to identify, based on the acquired similarity degrees, the procedure corresponding to the frame that is any one of the plurality of frames of the input-video data set from among the plurality of procedures.

3. The video manual generation apparatus according to claim 2, wherein the identifier is configured to:
calculate similarity degrees by executing a simple average of, or a weighted average of, similarity degrees obtained by using a current frame of the input-video data set and similarity degrees obtained by using a frame previous to the current frame; and
use the determination model to acquire, for the frame that is any one of the plurality of frames of the input-video data set, a procedure corresponding to the calculated similarity degrees.

4. The video manual generation apparatus according to claim 2, wherein the determination model is trained to learn, through non-hierarchical clustering, a relationship between the similarity degrees and a procedure represented by the frame corresponding to the frame image among the plurality of procedures.

5. The video manual generation apparatus according to claim 2,
wherein the determination model is trained with a plurality of training data sets,
wherein each of the plurality of training data sets is a set of input data and label data, the input data indicating similarity degrees for a frame that is any one of a plurality of frames of a plurality of video data sets, the label data indicating a procedure represented by the frame that is any one of the plurality of frames of the plurality of video data sets,
wherein the plurality of video data sets includes a first video data set to which information indicative of boundaries between the plurality of procedures is added,
wherein applying self-supervised learning to the plurality of video data sets causes information indicative of the boundaries between the plurality of procedures to be added to the video data sets other than the first video data set among the plurality of video data sets, and
wherein the label data is generated based on the information indicative of the boundaries between the plurality of procedures added to the plurality of video data sets.

6. The video manual generation apparatus according to claim 1, further comprising a text image generator configured to generate one or more text images in one-to-one correspondence with the one or more procedures based on the one or more input-procedure-text data sets,
wherein each of the one or more text images represents a corresponding procedure, and
wherein the video manual generator is configured to generate the video manual data by combining a text image corresponding to the procedure identified by the identifier with the frame image of the input-video data set.
